(19) United States
(12) Patent Application Publication
(10) Pub. No.: US 2026/0271822 A1
(43) Pub. Date: Sep. 17, 2026

(54) AQUEOUS EMULSIONS AND COATINGS FORMED THEREWITH

(71) Applicant: MICHELMAN, INC., Cincinnati, OH (US)

(72) Inventors: Hong ZHANG, Mason, OH (US); Tyler Alan REECE, Loveland, OH (US)

(73) Assignee: MICHELMAN, INC., Cincinnati, OH (US)

(21) Appl. No.: 19/471,304

(22) PCT Filed: Mar. 29, 2024
(86) PCT No.: PCT/US2024/022293

§ 371 Date: Sep. 30, 2025

Related U.S. Application Data
(60) Provisional application No. 63/493,932, filed on Apr. 3, 2023.

(51) Int. Cl. A01C 1/06

(52) U.S. Cl. CPC A01C 1/06

(57) ABSTRACT

Coatings may be used to discourage agglomeration and dust formation when handling seeds. Aqueous emulsions suitable for coating seeds and other substrates may comprise: an aqueous fluid; 5 wt. % to 60 wt. % of at least one wax, based on total solids; and 0.1 wt. % to 45 wt. % of at least one rosin acid, based on total solids, the at least one rosin acid being at least partially neutralized with at least one base. One or more additional additives may also be present in the aqueous emulsions.

### BACKGROUND

Dust formation can be problematic in a number of industries, with consequences of dust formation ranging from mere nuisance to severe health and safety hazards. Like many small particles, dust represents a potential inhalation hazard that may lead to adverse health effects, and under certain circumstances fine dust particles may be subject to flash ignition.

Handling and planting of seeds represents one area where dust formation may be problematic. For example, seed sowing equipment may lead to dust drift. Seeds may also be inherently prone to dust formation, since they may be small particles or contain small particles. Dust drift, also referred to as dust off, is a measure of the loss of particles from seeds when the seeds are handled. High dust off values are representative of excessive dust formation, Excessive dust off may liberate active ingredients from seeds or a coating thereon, such as fertilizers or herbicides, and thus impact crop growing efficacy. Moreover, studies have shown that excess dust formation during seed planting may have negative environmental impacts, such as having a deleterious effect on local honey bee populations.

Another issue commonly encountered when using seed sowing equipment is that of flowability, which refers to the ease with which dry seeds slide through internals of the seed sowing equipment. Low flowability values may lead to issues such as, for example, clumping of the seeds (sometimes referred to in the art as “bridging”), plugging of the seed sowing equipment in various locations, inconsistent seed flow through the seed sowing equipment, and uneven planting of the seeds, including placement of multiple seeds per hole or missing seeds in some holes. All of these factors may lead to inconsistent or sub-optimal planting of a given plot of farmland and, in turn, an undesired loss of crop yield.

To discourage the formation of dust and to encourage flowability, coatings are frequently applied to seeds, as well as to other types of substances that are prone to dust formation. Polymer coatings are frequently utilized for this purpose. Although polymer coatings may suppress dust formation and promote increased flowability in some cases, many polymer coatings are not readily dissolvable or biodegradable and thus may persist as microplastics in the environment for extended periods of time. Indeed, the environmental issues associated with microplastics are so impactful, the European Union has mandated a phase out of seed coatings capable of generating microplastics by the mid-2020s, and it is expected that other countries may follow suit in the coming years.

As a further issue, many coatings are unable to deliver satisfactory dust off and flow performance in combination with one another, especially those that extensively utilize bio-sourced or biodegradable materials, Many conventional bio-sourced components for seed coatings and other types of coatings are experiencing ongoing supply chain issues or may deliver coating performance that is less than desired. Thus, there is a desire to render coatings for seeds and other surfaces more readily biodegradable and/or environmentally friendly by utilizing higher percentages of (or exclusively) bio-sourced materials that are easily sourced while concurrently realizing coatings having exceptional performance for their intended application.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to one having ordinary skill in the art and having the benefit of this disclosure.

FIG. 1 is a diagram of an illustrative system for coating seeds using a drum coater according to various embodiments of the present disclosure,

FIG. 2 is a graph of abrasion resistance for coatings produced from several aqueous emulsions of the present disclosure.

FIGS. 3 and 4 are spider plots showing the performance of seeds coated with a rosin-free control and seeds coated with Sample E, respectively, each in comparison to a synthetic benchmark seed coating.

### DETAILED DESCRIPTION

The present disclosure generally relates to emulsion and coating technologies and, more specifically, aqueous emulsions and coatings formed therefrom that may lack microplastic-generating components.

As discussed above, dust formation may be problematic in various respects, including when handling and planting seeds. Polymer-containing seed coatings and other types of polymer coatings may promote ready flowability and suppress dust formation to varying degrees, but many types of such polymer coatings may be based on chemistries or technologies that render them as microplastics. As used herein, the term “microplastics” refers to polymer particles having a maximum size of about 5 mm in any dimension, wherein the polymer is non-biopolymer in nature (i.e., not naturally occurring), water-insoluble and non-biodegradable. Because microplastics are a growing environmental concern, polymer coatings that are defined as microplastics are currently being phased out, both for seeds and other substrates. At present, there are few viable alternatives for suppressing dust formation and promoting ready flowability when forming coatings upon seeds and other types of substrates, particularly using microplastics-free compositions.

The present disclosure provides aqueous emulsions and coatings formed therefrom that are freely biodegradable and may be formed from primarily or exclusively from biologically sourced materials or utilize synthetic materials that are themselves environmentally favorable, including materials that are biodegradable and/or water-soluble. In the disclosure herein, a material is considered to be water-soluble if the material has an aqueous solubility of about 2 g/L or greater at room temperature. Biodegradation may be established by OECD test method 301D. Other standard test methods for determining biodegradation include OECD test methods 301B, C, or F or OECD test method 310.

Thin-film coatings of the present disclosure may be produced upon a surface of seeds and other substrates using an aqueous emulsion that comprises an aqueous fluid, at least one wax, and at least one rosin acid that is at least partially neutralized with at least one base. Optionally, other additives such as, for example, at least one biopolymer, at least one water-soluble polymer, or any combination thereof may also be present in the thin-film coatings and aqueous emulsions, as discussed in further detail hereinbelow.

In particular, aqueous emulsions suitable for accomplishing the foregoing may comprise: an aqueous fluid; 5 wt. % to 60 wt. % or 10 wt. % to 60 wt. % of at least one wax, based on total solids; and 0.1 wt. % to 45 wt. % or 3 wt. % to 45 wt. % of at least one rosin acid, based on total solids, the at least one rosin acid being at least partially neutralized with at least one base. Total solids refer to all non-liquid on non-gaseous components blended into the aqueous emulsions, either in dissolved or dispersed (suspended) form. Additional compositional details follow below.

The aqueous emulsions of the present disclosure and thin-film coatings formed therefrom are substantially based upon chemistries that are not defined as microplastics, and therefore do not persist in the environment for extended periods of time, unlike currently used microplastics-based thin-film coatings. At the very least, the aqueous emulsions of the present disclosure may contain less microplastics-generating components than do conventional coatings. Preferably, the aqueous emulsions may be microplastics-free and afford thin-film coatings that are likewise microplastics-free. Advantageously, the aqueous emulsions and thin-film coatings of the present disclosure may incorporate all biologically sourced (natural) materials in some instances to further improve the environmental favorability. Even aqueous emulsions containing all biologically sourced materials may form robust thin-film coatings once dried upon various types of surfaces. The thin-film coatings may demonstrate a high degree of abrasion resistance.

As such, the aqueous emulsions of the present disclosure and thin-film coatings formed therefrom represent a potentially disruptive technology for formation of seed coatings and coatings upon other types of base substrates. Because naturally occurring materials are employed in the aqueous emulsions and thin-film coatings disclosed herein, they are more environmentally sustainable and renewable than are present technologies. Although the aqueous emulsions of the present disclosure may be particularly advantageous for forming coated seeds, it is to be appreciated that the aqueous emulsions may be similarly beneficial for forming thin-film coatings upon other types of base substrates as well.

Aqueous fluids suitable for use in the present disclosure may comprise water or water admixed with a water-miscible organic solvent, such as an alcohol or a glycol. Such water-miscible organic solvents may sometimes be present as an anti-freeze agent in the aqueous emulsions by lowering the freezing point of the aqueous fluid. In other embodiments, the aqueous fluids may be free of even water-miscible organic solvents. The aqueous fluids and aqueous emulsions may be acidic, neutral, or basic, depending upon particular application needs. A particular pH may be chosen to maintain the emulsion in emulsified form or to afford a particular protonation state for one or more components of the aqueous emulsion, for example. Buffering may be conducted, for example, if needed or desired. As such, the aqueous fluids and aqueous emulsions formed therefrom may have a pH ranging from about 1 to about 7, or about 2 to about 6, or about 1 to about 6, or about 6 to about 7, or about 6 to about 8, or about 7 to about 8, or about 7 to about 14, or about 8 to about 14, or about 8 to about 12, or about 7 to about 9. Preferably, to maintain the at least partial neutralization of the at least one rosin acid, the aqueous emulsions may have a pH of about 5 or greater, or about 6 or greater, or about 7 or greater, or about 8 or greater, such as about 5 to about 10, or about 7 to about 12, or about 7.5 to about 11, or about 8 to about 11.5.

The aqueous fluid may be present in the aqueous emulsions described herein in an amount up to about 90 wt. %, or up to about 80 wt. %, or up to about 70 wt. %, or up to about 60 wt. %, or up to about 50 wt. %, or up to about 40 wt. %, or up to about 30 wt. %, or up to about 20 wt. %, or up to about 15 wt. %, such as about 5 wt. % to about 20 wt. %, or about 10 wt. % to about 25 wt. %, or about 10 wt. % to about 30 wt. %, or about 15 wt. % to about 25 wt. %, or about 50 wt. % to about 80 wt. %, each as measured based on total mass of the aqueous emulsions.

The aqueous emulsions described herein may contain a high loading of total solids, some of which may be at least partially dissolved in the aqueous fluid and some of which may be dispersed or emulsified as particles in the aqueous fluid of the aqueous emulsion. For instance, in non-limiting examples of the aqueous emulsions disclosed herein, the wax may be dispersed as particles and the at least one rosin acid, depending on the extent of neutralization, may be dispersed as particles and/or be at least partially dissolved in the aqueous fluid of the aqueous emulsions. In illustrative embodiments, the aqueous emulsions described herein may contain about 5 wt. % to about 70 wt. % solids, or 5 wt. % to about 70 wt. % solids, or about 5 wt. % to about 60 wt. % solids, or about 10 wt. % to about 60 wt. % solids, or about 15 wt. % to about 60 wt. % solids, or about 15 wt. % to about 55 wt. % solids, or about 20 wt. % to about 50 wt. % solids, or about 35 wt. % to about 55 wt. % solids, based on total mass of the aqueous emulsion. In the foregoing, solids refer to both dissolved solids and dispersed/emulsified solids. The aqueous fluid may constitute the balance of mass within the aqueous emulsions. Solids in particulate form (emulsified/dispersed solids) may be present in the aqueous emulsions in particle sizes ranging from about 50 nm to about 5 μm in size or about 100 nm to about 5 μm in size, for example.

Suitable rosin acids may include acids such as abietic acid, pimaric acid, or any combination thereof. Other suitable rosin acids that may be present, either alone or in combination with abietic acid and/or pimaric acid, include, for example, neoabietic acid, dehydroabietic acid, palustric acid, levopimaric acid, and isopimaric acid. The one or more rosin acids may be sourced from gum rosin and are preferably substantially free of liquid terpenes after being liberated from gum rosin. Crude gum rosin lacking liquid terpenes may be utilized directly as a source of the one or more rosin acids when forming the aqueous emulsions in some cases.

Rosin acids or an at least partially neutralized form thereof may be present in the aqueous emulsions described herein in an amount up to about 50 wt. %, or up to about 45 wt. %, or up to about 40 wt. %, or up to about 30 wt. %, or up to about 20 wt. %, such as about 0.1 wt. % to 45 wt. %, or about 1 wt. % to about 45 wt. %, or about 3 wt. % to about 45 wt. %, or about 3 wt. % to about 25 wt. %, or about 3 wt. % to about 10 wt. %, or about 5 wt. % to about 45 wt. %, or about 15 wt. % to about 40 wt. %, or about 20 wt. % to about 35 wt. %, or about 20 wt. % to about 45 wt. %, each as measured based on the mass of total solids within the aqueous emulsions. Based on a combined mass of wax, rosin acid, base, and optional surfactant(s), the rosin acids may be present in the aqueous emulsions in an amount of 5 wt. % to about 50 wt. %, or about 10 wt. % to about 20 wt. %, or about 25 wt. % to about 50 wt. %, or about 30 wt. % to about 40 wt. %.

The at least one rosin acid may be at least partially neutralized in the aqueous emulsions and thin-film coatings disclosed herein, which is inclusive of full neutralization or partial neutralization. When fully neutralized, substantially all of the at least one rosin acid is converted to the corresponding rosin acid salt (e.g., an abietiate salt, a pimarate salt, and the like). When partially neutralized, a first portion of the at least one rosin acid is converted to at least one rosin acid salt and a second portion of the at least one rosin acid remains in a free carboxylic acid form. In non-limiting examples, at least about 20% by weight, or at least about 30% by weight, or at least about 40% by weight, or at least about 50% by weight, or at least about 60% by weight, or at least about 70% by weight, or at least about 80% by weight, or at least about 90% by weight of the at least one rosin acid is neutralized with a base. Preferably, when only a portion of the at least one rosin acid is neutralized, about 50% to about 95% by weight, or about 60% to about 95% by weight, or about 70% to about 90% by weight, or about 75% to about 95% by weight, or about 80% to about 95% by weight, or about 90% to about 99% by weight of the at least one rosin acid is neutralized.

When the at least one rosin acid is fully neutralized or a substantial majority of the at least one rosin acid is neutralized, the at least one rosin acid may be dissolved in the aqueous fluid. For example, when at least about 80% or more, or about 85% or more, or about 90% or more, or about 95% or more, or about 97% or more, or about 99% or more of the at least one rosin acid is neutralized, the at least one rosin acid may be dissolved in the aqueous fluid. When the at least one rosin acid is not neutralized or an insufficient amount of the at least one rosin acid is converted to a salt form, at least a portion of the at least one rosin acid may be dispersed as a plurality of solid particles in the aqueous fluid. Dispersion of the at least one rosin acid as a plurality of solid particles in the aqueous emulsions may be aided by at least one surfactant, examples of which are discussed further below.

Suitable bases for forming an at least partially neutralized rosin acid may include, but are not limited to, aqueous ammonia, an amine (e.g., ethanolamine, diethanolamine, triethanolamine, trimethylamine, diethylamine, dimethylethylamine, triethylamine, and the like), or alkali metal base (e.g., NaOH, KOH, or the like). Combinations of these bases may be used. Once the at least one rosin acid has been at least partially neutralized and incorporated in an aqueous emulsion according to the description above, the pH of the aqueous emulsion may be further adjusted, if needed. Suitable pH ranges are provided above.

A crosslinking agent may be present in the aqueous emulsions, if desired. If an amine is used to perform the neutralization of the at least one rosin acid, and excess amine groups remain present, the excess amine groups may react with epoxide groups in the crosslinking agent to promote covalent bond formation. Suitable examples of crosslinking agents containing epoxide groups will be familiar to one having ordinary skill in the art.

Waxes are hydrophobic organic substances that occur in petroleum and other oleaginous materials, are biosynthesized by plants and animals, or are obtained synthetically. Waxes are usually malleable solids at room temperature and may comprise one or more higher alkanes (paraffins), particularly normal or branched C₁₆-C₁₀₀ alkanes or C₂₀-C₅₀ alkanes, lipids and/or oils. In the disclosure herein, the at least one wax may be dispersed as a plurality of solid wax particles in the aqueous fluid of the aqueous emulsion. The at least one wax may remain as solid wax particles once a thin-film coating has been formed from the aqueous emulsion.

Suitable waxes for use in the disclosure herein may include, but are not limited to, paraffin waxes (including Fischer-Tropsch waxes), oxidized paraffin waxes, polyolefin waxes, oxidized polyolefin waxes, natural waxes, oxidized natural waxes, and any combination thereof. As used herein, a wax is considered “oxidized” if oxygenated functional groups such as alcohols, carboxylic acids, epoxides or the like are introduced to an otherwise unsubstituted (paraffinic) hydrocarbon backbone. The amount of oxygenated functional groups introduced to a particular oxygenated wax may, for example, be sufficient to lower the hydrophobicity of the wax to an extent necessary to facilitate formation of an emulsified form of the wax.

Specific examples of suitable paraffin waxes and lipidic waxes for use in the disclosure herein may include, but are not limited to, slack wax, beeswax, hydrogenated lipids, refined wax, semi-refined wax, scale wax, microcrystalline wax, beeswax, vegetable-based waxes such as soy and palm waxes, carnauba wax, rice bran wax, montan ester wax, sugar cane wax, sunflower wax, shellac wax, hydrogenated castor oil, poly(3-hydrobuyrate-co-3-hydroxyvalerate), synthetic waxes such as oligomer waxes derived from linear alpha olefins or copolymers thereof, Fischer-Tropsch waxes, polyolefin waxes (e.g., polyethylene wax or polypropylene wax), and any combination thereof. Suitable waxes may be sourced as a wax emulsion in an aqueous fluid, which may then be further formulated with at least one rosin acid to form the aqueous emulsions described herein. Examples of wax emulsions that may be used in the disclosure herein include, but are not limited to, MICHEM® emulsions such as ME62330, ME93335, ME61335, ME52137, and ME24414 (Michelman).

Particularly suitable waxes for use in the disclosure herein may be a wax obtained from a biological source (natural waxes/naturally sourced waxes), such as any plant- or animal-based wax listed above, or a wax which is also biodegradable. Thus, in particular embodiments, the at least one wax may comprise or consist of at least one naturally sourced wax in the disclosure herein. It is to be appreciated, however, that certain synthetic waxes, such as some Fischer-Tropsch waxes, also allow microplastics-free formulations to be maintained and may similarly be suitable for use in the disclosure herein. Accordingly, in more specific examples of the present disclosure, the at least one wax may comprise or consist of at least one naturally sourced wax (e.g., carnauba wax, rice bran wax, montan ester waxes, vegetable waxes such as soy or palm wax, beeswax, sugar cane wax, sunflower wax, or the like), at least one Fischer-Tropsch wax, or any combination thereof.

Suitable waxes for incorporation within the aqueous emulsions of the present disclosure may have a melting point of about 50° C. or above and an average particle size (diameter), when emulsified, ranging up to about 50,000 nm (50 microns) in size, or up to about 1,000 nm in size, or up to about 500 nm in size, such as about 300 nm or less, or about 200 nm or less, or about 100 nm or less, preferably an average diameter ranging from about 10 nm to about 100 nm, or about 25 nm to about 50 nm, or about 50 nm to about 90 nm, or about 20 nm to about 75 nm.

Waxes may be present in the aqueous emulsions described herein in an amount up to about 60 wt. %, or up to about 50 wt. %, or up to about 40 wt. %, or up to about 30 wt. %, such as about 5 wt. % to about 60 wt. %, or about 10 wt. % to about 60 wt. %, or about 5 wt. % to about 40 wt. %, or about 15 wt. % to about 35 wt. %, or about 20 wt. % to about 30 wt. %, each as measured based on the mass of total solids within the aqueous emulsions. Based on a combined mass of wax, rosin acid, base, and optional surfactant(s), the wax may be present in the aqueous emulsions in an amount of 30 wt. % to about 80 wt. %, or about 35 wt. % to about 50 wt. %, or about 40 wt. % to about 60 wt. %, or about 60 wt. % to about 80 wt. %.

A mass ratio of the at least one wax to the at least one rosin acid (or an at least partially neutralized form thereof) may range from about 1:1 to about 10:1, or about 1:1 to about 5:1, or about 1:1 to about 3:1, or about 1:1 to about 2:1, or about 1:1 to about 1.2:1, or about 1.2:1 to about 1.5:1, or about 1.5:1 to about 2:1.

Optionally, the aqueous emulsions and coating formed therefrom may comprise up to about 30 wt. %, or up to about 40 wt. %, or up to about 50 wt. %, or up to about 60 wt. %, or up to about 70 wt. % of additional additives, again based upon total solids. Additional additives that may be present, either alone or in combination with one another include, but are not limited to, at least one biopolymer, at least one water-soluble synthetic polymer, at least one surfactant (preferably at least one anionic surfactant optionally in further combination with at least one neutral surfactant, more preferably where the at least one anionic surfactant and/or the at least one neutral surfactant is biodegradable), at least one biocide, at least one effect pigment, at least one crosslinking agent, at least one plasticizer or any combination thereof. Other inert components such as fillers, preservatives, buffers, and the like may also be present as additional additives.

In some embodiments, the aqueous emulsions and coatings formed therefrom may include at least one biopolymer, at least one water-soluble synthetic polymer, or any combination thereof. Preferably, the at least one biopolymer and/or the at least one water-soluble synthetic polymer may be biodegradable. Biodegradability may be assessed as described above.

Examples of synthetic polymers exhibiting water solubility and/or biodegradability that may be suitable for use in the disclosure herein include, but are not limited to, a polyethylene glycol, a polyvinyl pyrrolidone, a polyvinyl alcohol, a poly(meth)acrylic acid, a polylactic acid, a polyglycolic acid, any copolymer thereof, or any combination thereof. Although poly(meth)acrylic acid may be considered to constitute a microplastic in some jurisdictions, this polymer may be used in aqueous emulsions and coatings where a microplastics-free standard need not necessarily be maintained, or a suitable co-monomer may be introduced into poly(meth)acrylic acid to promote water solubility or biodegradability. Suitable copolymers of the foregoing polymers may include any co-monomer that permits the parent polymer to maintain water solubility and/or biodegradability, for example. In some examples, the co-monomer may be vinyl acetate. In more particular embodiments, the aqueous emulsions may comprise one or more of a polyvinyl alcohol, a polyvinylpyrrolidone, a vinylpyrrolidone-co-vinyl acetate copolymer, or any combination thereof.

If included, the plasticizer may be present in the aqueous emulsions described herein in an amount up to about 30 wt. %, or up to about 20 wt. %, or up to about 15 wt. %, or up to about 10 wt. %, or up to about 5 wt. %, or up to about 1 wt. %, such as about 1 wt. % to about 30 wt. %, or about 10 wt. % to about 30 wt. %, or about 5 wt. % to about 25 wt. %, or about 15 wt. % to about 25 wt. %, as measured based on total solids within the aqueous emulsion.

The aqueous emulsions disclosed herein may comprise a suitable plasticizer. Suitable examples for the plasticizer are not believed to be particularly limited, other than being dispersible in an aqueous emulsion of the present disclosure and being capable of promoting robust thin film formation once the aqueous emulsions are deposited upon the surface of a base substrate and dried. Some examples of suitable plasticizers may be derived from a biological source, although non-biologically sourced plasticizers may also be used. Specific examples of suitable plasticizers may include, but are not limited to, epoxidized soybean oil, epoxidized linseed oil, castor oil, tannic acid, milk proteins, polyethylene glycol, or any combination thereof. Still other examples of plasticizers may be suitable such as, for example, epoxidized sunflower oil, cardanol and modified cardanol, glycidol, chlorine- and phosphate-containing vegetable based plasticizers, phosphaphenanthrene-modified vegetable oils, hydroxyl- and nitrogen-group-containing tung oil esters, dimethyl oleate-based plasticizers, citric acid esters, and the like.

If included, the plasticizer may be present in the aqueous emulsions described herein in an amount up to about 10 wt. %, or up to about 5 wt. %, or up to about 4 wt. %, or up to about 3 wt. %, or up to about 2 wt. %, or up to about 1 wt. %, such as about 0.1 wt. % to about 1.5 wt. %, or about 0.5 wt. % to about 2 wt. %, or about 0.7 wt. % to about 1.7 wt. %, or about 0.8 wt. % to about 2 wt. %, as measured based on total solids within the aqueous emulsion.

Additional components may also be present in the aqueous emulsions disclosed herein such as one or more of, for example, effect pigments (colorants), dyes, optical brighteners, crosslinking agents, defoamers, anti-static agents, dispersants, thickeners, fillers, biocides, herbicides, rheology modifiers (e.g., hydrophobically modified ethoxylated polyurethanes and similar rheology-modifying polymers), fluency aids, lubricants, preservatives (e.g., benzoisothiazolinones, methylisothiazolinones, methylchloroisothaizolinones, and the like), coalescent aids, other emulsified polymers, buffers, co-solvents, surfactants, and any combination thereof. Such additional components may be present in amounts conventionally present in aqueous emulsions useful in coating applications. Other examples of additional components that may be present when the aqueous emulsions are utilized for forming a thin-film coating upon seeds may include, but are not limited to, fertilizers, nutrients, moisture modifiers, and the like. The total amount of additional components may be up to about 30 wt. %, based on total solids within the aqueous emulsions. All of the foregoing additional components need not necessarily be present in a given aqueous emulsion or thin-film coating. Zero, one or more than one of each type of additional component may be present in any combination within the aqueous emulsions and thin-film coatings of the present disclosure. Suitable examples of these additional components will be familiar to persons having ordinary skill in the art of emulsion and coating technologies.

When used, additional components may be selected independently from one another to modify one or more properties of the aqueous emulsions (e.g., to promote formation of a thin-film coating) or to promote suitability for a given application. For example, when being utilized as a coating for seeds or other type of surface for which coloration is important, one or more effect pigments or dyes may be present within the aqueous emulsions. In other cases, such as when being used to form a primer coating upon other surfaces such as paper or cardboard, for example, effect pigments, dyes, and other colorants may be optionally omitted. Crosslinking agents may be present or absent when forming a primer coating as well.

Illustrative surfactants that may be suitable for use in the aqueous emulsions disclosed herein are not believed to be particularly limited and may include any of cationic surfactants, anionic surfactants, neutral surfactants (non-ionic surfactants), zwitterionic surfactants, and any combination thereof. Preferably, to promote dispersion of the at least one rosin acid, particularly when the at least one rosin acid is incompletely neutralized, the at least one surfactant may comprise at least one anionic surfactant and optionally, at least one neutral surfactant. Suitable surfactants individually may be present in an amount up to about 25 wt. %, or up to about 20 wt. %, or up to about 15 wt. %, or up to about 10 wt. %, or up to about 8 wt. %, or up to about 5 wt. %, or up to about 4 wt. %, or up to about 3 wt. %, or up to about 2 wt. %, or up to about 1 wt. %, or up to about 0.5 wt. %, as measured based upon total solids in the aqueous emulsions. The total amount of surfactants in the aqueous emulsions may be up to about 30 wt. %, or up to about 25 wt. %, or up to about 20 wt. %, or up to about 15 wt. %, or up to about 10 wt. %, or up to about 5 wt. %, or up to about 1 wt. % Illustrative non-ionic surfactants that may be suitable for use in the disclosure herein include, but are not limited to, alkylaryl polyether alcohols, alkylphenol ethoxylates, alkyl ethoxylates, polyoxamers, fatty acid esters (e.g., fatty acid glycerol esters, fatty acid sorbitan esters, fatty acid sorbitol esters (polysorbates), fatty acid lecithin esters, and the like), polyethylene oxide sorbitan fatty acid esters, and any combination thereof. Illustrative anionic surfactants that may be suitable for use in the disclosure herein include, but are not limited to, alkyl ethoxylate sulfates, alkyl ethoxylate sulfonates, alkylphenol ethoxylate sulfates, alkylphenol ethoxylate sulfonates, alkylsulfates, alkylsulfonates, alkylarylsulfates, alkylarylsulfonates, sulfosuccinates, and any combination thereof. Phosphate anionic surfactants may also be used. Illustrative zwitterionic surfactants that may be suitable for use in the disclosure herein include various betaines and sultaines.

Any of the components within the aqueous emulsions and coatings formed therefrom may be optionally crosslinked, either with an organic crosslinking agent (e.g., an amine in the case of crosslinking an epoxide) or a metal atom that promotes crosslinking through metal-ion complexation. Suitable examples of crosslinking agents that may promote crosslinking through metal-ion complexation include, but are not limited to, zinc oxide, magnesium oxide, ammonium zirconium carbonate, and others, such as various transition metal compounds.

Coatings (thin-film coatings) may be formed by providing a base substrate; contacting a surface of the base substrate with an aqueous emulsion of the present disclosure; and removing the aqueous fluid from the surface to produce a coated substrate comprising a thin-film coating comprising the at least one wax and the at least one rosin acid. More specifically, such coated substrates may comprise a base substrate, a thin-film coating formed upon a surface of the base substrate and comprising 10 wt. % to 60 wt. % of at least one wax, based on total mass of the thin-film coating, and 3 wt. % to 45 wt. % of the at least one rosin acid, based on total mass of the thin-film coating, in which the at least one rosin acid is at least partially neutralized with at least one base.

Types of base substrates upon which thin-film coatings may be formed using the aqueous emulsions of the present disclosure are not believed to be particularly limited, provided that there is adequate adhesion between the surface of the base substrate and the thin-film coating. In non-limiting examples, base substrates that may be coated using the aqueous emulsions include, but are not limited to, seeds, paper, cardboard and other types of packaging, wood (e.g., for architectural coatings), metal (e.g., a metal can), other polymers (e.g., within polymer-based circuit board assemblies), and the like. Similarly, the aqueous emulsions described herein may be used to coat sizing upon fibers as well. When used to form a coating upon paper and other substrates in which the coating should be inconspicuous, the aqueous emulsions may be formulated to provide optical clarity once dried.

Application of the aqueous emulsion to the base substrate may be achieved using any of a variety of methods such as, for example, immersion (dip coating), spraying, rod or roller coating, tumbling, or through using equipment such as a size press, water box, a blade coater, a cast coater, a rod coater, an air knife coater, a curtain coater, a film press coater, a flexo coater, a batch coater, a drum coater, the like, or any combination thereof. The chosen coating method may depend on the particular type of base substrate to be coated.

In more particular examples, the base substrate may comprise a plurality of seeds. The resulting coated seeds may comprise a base seed, and a thin-film coating formed upon a surface of the base seed, wherein the thin-film coating comprises 5 wt. % to 60 wt. % or 10 wt. % to 60 wt. % of at least one wax, based on total mass of the coating, and 0.1 wt. % to 45 wt. % or 3 wt. % to 45 wt. % of the at least one rosin acid, based on total mass of the coating, in which the at least one rosin acid is at least partially neutralized with at least one base. The aqueous emulsions may be contacted with a plurality of base seeds to form the thin-film coating by spraying the aqueous emulsion onto the plurality of seeds, tumbling the plurality of seeds with the aqueous emulsion, or any combination thereof.

The thin-film coating upon a seed may have a coating weight of about 50 mL to about 200 mL, or about 200 mL to about 400 mL, or about 400 mL to about 900 mL, or about 900 mL to about 1350 mL, each per 45.4 kg of seed. Depending on the seed, the thin-film coating may have a thickness of about 0.5 microns to about 5.0 microns. Examples of seeds that may have a thin-film coating introduced thereto according to the present disclosure include, for example, cereals, vegetables, ornamentals, and fruits. More specific examples of seeds that may be coated according to the disclosure herein include, for instance, soybean seeds, corn seeds, cotton seeds, rice seeds, oat seeds, rye seeds, barley seeds, vegetable seeds, wheat seeds, sunflower seeds, lettuce seeds, spinach seeds, or the like.

Coating thicknesses of thin-film coatings formed upon other types of base substrates according to the present disclosure may range from about 1 μm to about 400 μm, or about 10 μm to about 100 μm, or about 50 μm to about 300 μm, or about 75 μm to about 225 μm. Coating thicknesses may be selected based on their suitability for a given application.

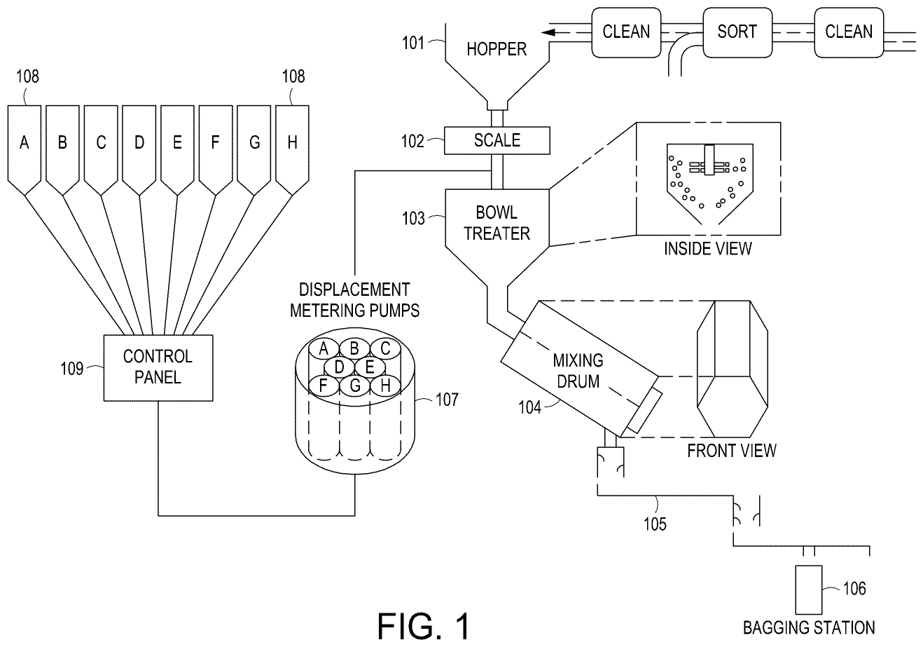

FIG. 1 is a diagram of an illustrative system for coating seeds using a drum coater according to various embodiments of the present disclosure. As shown in FIG. 1, seeds are cleaned, sorted, and added to supply hopper 101. The seeds flow through supply hopper 101 to scale 102 and into bowl treater 103. Supply hopper 101 and scale 102 control the rate of seed flow into bowl treater 103. In bowl treater 103, the seeds pass through a zone of sprayed or atomized coating material. The seeds then pass from bowl treater 103 into mixing drum 104.

Mixing drum 104 rotates the seeds and the seed coating components, thereby ensuring that each seed is substantially completely coated with the seed coating. Evaporation of the aqueous fluid may take place during the course of this process, thereby leaving the other components disposed upon the outer surface of the seed as the thin-film coating. Heating and/or application of vacuum may take place in some instances to promote more rapid evaporation of the aqueous fluid. The coated seeds then exit through an opening of mixing drum 104. Coated seeds exiting mixing drum 104 may contact one or more conveyor belts 105 which transport the seeds to bagging station 106.

The drum coater may include one or more of metering pump 107 that provides the aqueous emulsion to bowl treater 103. In particular, metering pump 107 draws the aqueous emulsion from one or more tanks 108 as directed by control panel 109.

It is to be appreciated that seed coatings having a composition as described herein need not necessarily be deposited from a single aqueous emulsion as defined above. That is, one or more components of the thin-film coating may be applied to a plurality of seeds, optionally in emulsified form, individually or together with an aqueous emulsion lacking those one or more components. Accordingly, the components that make up a thin-film coating upon a seed or other type of base substrate may be coated on the seed or other surface simultaneously or substantially simultaneously independently of whether or not they are mixed together in a single aqueous emulsion prior to coating. Alternately, the components of the thin-film coating may be applied to the seed or base substrate separately from one another at different times. When applied to a seed or other base substrate at different times, the thin-film coating may have a concentration gradient or discontinuity with respect one or more components.

Embodiments disclosed herein include:
A. Aqueous emulsions. The aqueous emulsions comprise: an aqueous fluid; 5 wt. % to 60 wt. % of at least one wax, based on total solids; and 0.1 wt. % to 45 wt. % of at least one rosin acid, based on total solids, the at least one rosin acid being at least partially neutralized with at least one base.
B. Coated substrates. The coated substrates comprise: a base substrate; and a thin-film coating formed upon a surface of the base substrate and comprising: 5 wt. % to 60 wt. % of at least one wax, based on total mass of the coating; 0.1 wt. % to 45 wt. % of at least one rosin acid, based on total mass of the coating, the at least one rosin acid being at least partially neutralized with at least one base.
C. Coating methods. The coating methods comprise: providing a base substrate; contacting a surface of the base substrate with the aqueous emulsion of A; and removing the aqueous fluid from the surface of the base substrate to produce a coated substrate having a thin-film coating comprising the at least one wax and the at least one rosin acid.

Each of embodiments A-C may have one or more of the following additional elements in any combination:
Element 1: wherein the at least one rosin acid is substantially free of liquid terpenes.
Element 2: wherein the at least one wax comprises at least one naturally sourced wax.
Element 3: wherein the at least one base comprises a base selected from the group consisting of aqueous ammonia, an amine, an alkali metal hydroxide, and any combination thereof.
Element 4: wherein the at least one wax is selected from the group consisting of at least one naturally sourced wax, at least one Fischer-Tropsch wax, and any combination thereof.
Element 4A: wherein the at least one wax consists of one or more naturally sourced waxes.
Element 5: wherein the at least one naturally sourced wax comprises at least carnauba wax, rice bran wax, montan ester wax, soy wax, palm wax, beeswax, sugar cane wax, sunflower wax, or any combination thereof.
Element 6: wherein the at least one rosin acid is fully neutralized with the at least one base.
Element 7: wherein the at least one rosin acid is dissolved in the aqueous fluid.
Element 8: wherein the aqueous fluid comprises about 15 wt. % to about 70 wt. % solids, based on total mass of the aqueous emulsion.
Element 9: wherein the aqueous emulsion further comprises at least one biopolymer, at least one water-soluble polymer, at least one surfactant, at least one biocide, at least one effect pigment, or any combination thereof.
Element 10: wherein the at least one biopolymer, the at least one water-soluble polymer, or any combination thereof is present.
Element 11: wherein the at least one surfactant is present, and the at least one surfactant comprises at least one anionic surfactant, at least one neutral surfactant, or any combination thereof.
Element 12: wherein the at least one surfactant is biodegradable.
Element 13: wherein the base substrate comprises a plurality of seeds.
Element 14: wherein contacting comprises spraying the aqueous emulsion onto the plurality of seeds, or tumbling the plurality of seeds with the aqueous emulsion.

By way of non-limiting example, exemplary combinations applicable to A-C include, but are not limited to, 2, 4, 4A, or 5, and 3; 2, 4, 4A, or 5, and 6; 2, 4, 4A, or 5, and 6 and 7; 2, 4, 4A, or 5, and 8; 2, 4, 4A, or 5, and 9; 2, 4, 4A, or 5, and 10; 2, 4, 4A, or 5, and 11; 3 and 6; 3, 6, and 7; 3 and 8; 3 and 9; 3 and 10; 3 and 11; 6 and 8; 6-8; 6 and 9; 6 and 10; 6 and 11; 8 and 9; 8 and 10; 8 and 11; 9 and 10; 9 and 11; and 10 and 11. Any of the foregoing or any one of 1-12 may be in further combination with 13 and/or 14.

To facilitate a better understanding of the disclosure herein, the following examples of various representative embodiments are given. In no way should the following examples be read to limit, or to define, the scope of the present disclosure.

### EXAMPLES

Aqueous wax emulsions were prepared by combining components as specified in Tables 1A and 1B. The wax emulsion was combined in various ratios with an aqueous rosin acid emulsion (Tables 2A and 2B) containing partially neutralized rosin acid or a rosin acid solution (Table 3) containing fully neutralized rosin acid to produce a combined aqueous emulsion suitable for producing a thin-film coating. Tables 4-7 (containing partially neutralized rosin acid, Samples A-D) and Tables 8-9 (containing fully neutralized rosin acid, Samples E-F) specify the final compositions of the various aqueous emulsions.

TABLE 1A
Wax Emulsion A

| | Wt. % Based on Total |
|---|---|
| Component | Components Added to Water |
| Carnauba wax | 83.46 |
| Non-Ionic Surfactant | 16.23 |
| Base | 0.19 |
| Preservatives | 0.12 |

TABLE 1B
Wax Emulsion B

| | Wt. % Based on Total |
|---|---|
| Component | Components Added to Water |
| Carnauba wax | 83.02 |
| Non-Ionic Surfactant | 8.30 |
| Anionic Surfactant | 8.55 |
| Preservatives | 0.13 |

TABLE 2A
Rosin Acid Emulsion A
(100 nm emulsion particle size, 32.57% neutralization)

| | Wt. % Based on Total |
|---|---|
| Component | Components Added to Water |
| Gum Rosin | 63.61 |
| Base | 9.08 |
| Non-Ionic Surfactants | 27.18 |
| Preservatives | 0.13 |

TABLE 2B
Rosin Acid Emulsion B
(250 nm emulsion particle size, 17.02% neutralization)

| | Wt. % Based on Total |
|---|---|
| Component | Components Added to Water |
| Gum Rosin | 75.49 |
| Base | 5.64 |
| Non-Ionic Surfactant | 5.64 |
| Anionic Surfactant | 13.23 |

TABLE 3
Rosin Acid Solution
(100% neutralization)

| | Wt. % Based on Total |
|---|---|
| Component | Components Added to Water |
| Rosin Acid | 68.54 |
| Base | 29.37 |
| Non-Ionic Surfactant | 1.96 |
| Preservatives | 0.13 |

TABLE 4
Combined Emulsion-Sample A
(Rosin Acid Emulsion B + Wax Emulsion B)

| | Wt. % Based on Total |
|---|---|
| Component | Components Added to Water |
| Carnauba Wax | 18.03 |
| Gum Rosin | 11.77 |
| Base | 1.68 |
| Non-Ionic Surfactants | 6.84 |
| Anionic Surfactant | 1.85 |
| Other Components | 59.82 |

TABLE 5
Combined Emulsion-Sample B
(Rosin Acid Emulsion B + Wax Emulsion B)

| | Wt. % Based on Total |
|---|---|
| Component | Components Added to Water |
| Carnauba Wax | 18.16 |
| Gum Rosin | 14.58 |
| Base | 2.08 |
| Non-Ionic Surfactants | 8.05 |
| Anionic Surfactant | 1.86 |
| Other Components | 55.27 |

TABLE 6
Combined Emulsion-Sample C
(Rosin Acid Emulsion B + Fischer-Tropsch Wax)

| | Wt. % Based on Total |
|---|---|
| Component | Components Added to Water |
| Fischer Tropsch Wax | 25.12 |
| Gum Rosin | 10.26 |
| Base | 0.77 |
| Non-Ionic Surfactants | 7.22 |
| Anionic Surfactant | 1.79 |
| Other Components | 54.85 |

TABLE 7
Combined Emulsion-Sample D
(Rosin Acid Emulsion B + Wax Emulsion B)

| | Wt. % Based on Total |
|---|---|
| Component | Components Added to Water |
| Carnauba Wax | 17.32 |
| Gum Rosin | 19.77 |
| Base | 1.48 |
| Non-Ionic Surfactants | 3.20 |
| Anionic Surfactant | 5.23 |
| Other Components | 53.00 |

TABLE 8
Combined Emulsion-Sample E
(Rosin Acid Solution + Wax Emulsion A)

| | Wt. % Based on Total |
|---|---|
| Component | Components Added to Water |
| Carnauba Wax | 41.67 |
| Gum Rosin | 5.94 |
| Base | 2.65 |
| Non-Ionic Surfactants | 8.28 |
| Other Components | 41.46 |

TABLE 9
Combined Emulsion-Sample F
(Rosin Acid Solution + Wax Emulsion A)

| | Wt. % Based on Total |
|---|---|
| Component | Components Added to Water |
| Carnauba Wax | 19.21 |
| Gum Rosin | 14.94 |
| Base | 6.45 |
| Non-Ionic Surfactants | 4.17 |
| Other Components | 55.23 |

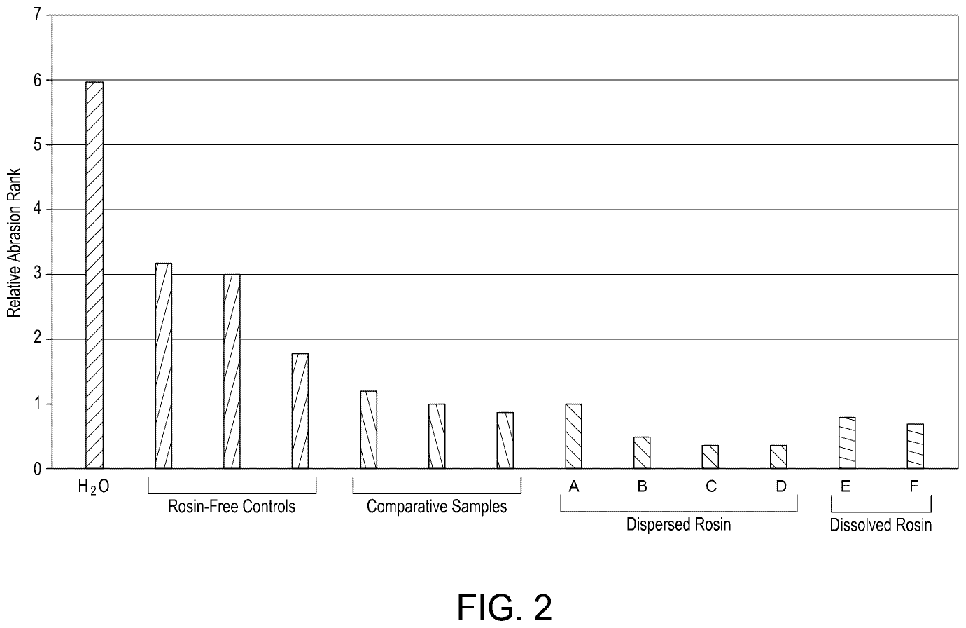

FIG. 2 is a graph of relative abrasion resistance for base substrates coated with thin-film coatings produced from several aqueous emulsions of the present disclosure in comparison to rosin-free controls and commercial comparative samples. As shown, the thin-film coatings of the present disclosure afforded comparable or even superior performance to the commercial controls. The abrasion resistance in control thin-film coatings lacking the rosin acid was considerably poorer.

Seed Coating Procedure. Aqueous emulsions prepared as above were coated onto corn or soybean seeds using standard seed coating procedures. In brief, 20 grams of a slurry containing the aqueous emulsion and pesticides was contacted with 1 kg of seeds in a standard seed coating apparatus. After 30 seconds of contact, the seeds were recovered from the seed coater and allowed to dry 18-24 hours.

Once the coating had dried upon the surfaces of the individual seeds, further testing was performed to evaluate dry flow and dust formation (dust off) performance of the coated seeds. For measuring dry flow performance, 400 g of seeds were placed in the seed flow meter. Flow was measured as the mass of seeds that flowed through the meter in 0.4 seconds. Dividing the mass by the flow time provided the reported dry flow rates. Dry flow measurements were conducted 8 times, and the results were averaged. For Heubach dust off performance, 100 g of seeds were placed in a Heubach dust off apparatus, along with a pre-weighed filter. After 300 cycles of rotation, the seeds and the filter were each weighed. The mass collected on the filter was utilized to determine the reported dust off values.

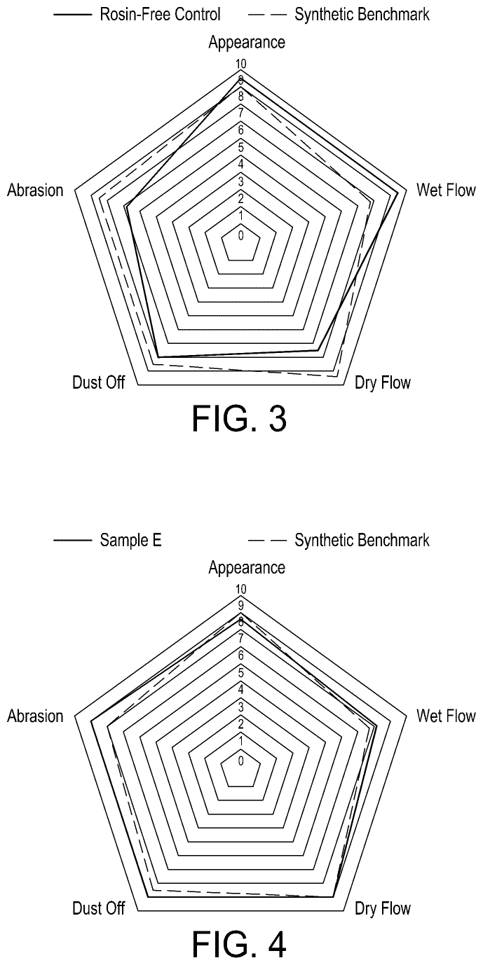

FIGS. 3 and 4 are spider plots showing the performance of seeds coated with a rosin-free control and seeds coated with Sample E, respectively, each in comparison to a synthetic benchmark seed coating. As shown, Sample E gave comparable performance to the synthetic benchmark seed coating. The rosin-free control, in contrast, gave poorer abrasion and dry flow performance.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. An aqueous emulsion comprising:
an aqueous fluid;
5 wt. % to 60 wt. % of at least one wax, based on total solids; and
0.1 wt. % to 45 wt. % of at least one rosin acid, based on total solids, the at least one rosin acid being at least partially neutralized with at least one base.

2. The aqueous emulsion of claim 1, wherein the at least one rosin acid is substantially free of liquid terpenes.

3. (canceled)

4. The aqueous emulsion of claim 1, wherein the at least one base comprises a base selected from the group consisting of aqueous ammonia, an amine, an alkali metal hydroxide, and any combination thereof.

5. The aqueous emulsion of claim 1, wherein the at least one wax is selected from the group consisting of at least one naturally sourced wax, at least one Fischer-Tropsch wax, and any combination thereof.

6. (canceled)

7. The aqueous emulsion of claim 1, wherein the at least one wax consists of one or more naturally sourced waxes.

8. The aqueous emulsion of claim 7, wherein the at least one naturally sourced wax comprises at least one of carnauba wax, rice bran wax, montan ester wax, soy wax, palm wax, beeswax, sugar cane wax, sunflower wax, or any combination thereof.

9. The aqueous emulsion of claim 1, wherein the at least one rosin acid is fully neutralized with the at least one base.

10. The aqueous emulsion of claim 9, wherein the at least one rosin acid is dissolved in the aqueous fluid.

11. The aqueous emulsion of claim 1, wherein the aqueous fluid comprises about 15 wt. % to about 70 wt. % solids, based on total mass of the aqueous emulsion.

12. The aqueous emulsion of claim 1, further comprising:
at least one biopolymer, at least one water-soluble polymer, at least one surfactant, at least one biocide, at least one effect pigment, or any combination thereof.

13. (canceled)

14. (canceled)

15. (canceled)

16. A coated substrate comprising:
a base substrate; and
a thin-film coating formed upon a surface of the base substrate and comprising:
5 wt. % to 60 wt. % of at least one wax, based on total mass of the coating; and
0.1 wt. % to 45 wt. % of at least one rosin acid, based on total mass of the coating, the at least one rosin acid being at least partially neutralized with at least one base.

17. (canceled)

18. The coated substrate of claim 16, wherein the at least one base comprises a base selected from the group consisting of aqueous ammonia, an amine, an alkali metal hydroxide, and any combination thereof.

19. The coated substrate of claim 16, wherein the at least one wax is selected from the group consisting of at least one naturally sourced wax, at least one Fischer-Tropsch wax, and any combination thereof.

20. (canceled)

21. The coated substrate of claim 16, wherein the at least one wax consists of one or more naturally sourced waxes.

22. (canceled)

23. The coated substrate of claim 16, wherein the at least one rosin acid is fully neutralized with the at least one base.

24. The coated substrate of claim 16, further comprising:
at least one biopolymer, at least one water-soluble synthetic polymer, at least one surfactant, at least one biocide, at least one effect pigment, or any combination thereof.

25. (canceled)

26. (canceled)

27. (canceled)

28. The coated substrate of claim 16, wherein the base substrate comprises a plurality of seeds.

29. A method comprising:
providing a base substrate;
contacting a surface of the base substrate with the aqueous emulsion of claim 1; and
removing the aqueous fluid from the surface of the base substrate to produce a coated substrate having a thin-film coating comprising the at least one wax and the at least one rosin acid.

30. The method of claim 29, wherein the base substrate comprises a plurality of seeds.

31. The method of claim 30, wherein contacting comprises spraying the aqueous emulsion onto the plurality of seeds, or tumbling the plurality of seeds with the aqueous emulsion.

32. The method of claim 29, wherein the at least one wax is selected from the group consisting of at least one naturally sourced wax, at least one Fischer-Tropsch wax, and any combination thereof.

33. The method of claim 29, wherein the at least one wax consists of one or more naturally sourced waxes.

34. The method of claim 29, wherein the at least one rosin acid is fully neutralized with the at least one base.
